(19) United States
(12) Patent Application Publication
(10) Pub. No.: US 2003/0158783 A1
(43) Pub. Date: Aug. 21, 2003

(54) Web shopping system and method

(76) Inventor: Mao-Yu Lin, Taipei (TW)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 10/075,622

(22) Filed: Feb. 15, 2002

(51) Int. Cl. G06F 17/60

(52) U.S. Cl. 705/26

(57) ABSTRACT

A web shopping system and method for electronic devices accessible to the Internet is disclosed. Through the OI of the system, a user can enter keywords and obtain commodity item and location information related to the keywords from a designated area after the system is connected to the Internet. By clicking in a purchase order, the user determines which commodity to buy and where to buy. The system then determines appropriate payment and delivery methods, achieving the goal of satisfactory web shopping.

### BACKGROUND OF THE INVENTION

1. Field of Invention

The invention relates to a web shopping system and method. More particularly, the invention relates to a system and method used on an electronic device accessible to a network for obtaining commodity sale information and performing transactions by entering keywords through the OI (operating interface) of the system.

2. Related Art

During the birth of mobile phones, their functions are mainly limited to those of ordinary telephones. The only extra function of them is to allow users to talk at any place and any time. With the advance in computer technology, the computer technology has gradually spread out in all sorts of areas due to the rapid exchanges of information and become an indispensable part of daily life. In order for people to thoroughly, rapidly, and accurately get hold of latest information, different electronic products with various kinds of software and hardware have been invented. For example, IA's (information appliance) and even mobile phones and PDA's (personal digital assistant) have the function of information connections once they are connected to a mobile information service center. The invention of these products does not only provide consumers with ample information but also help them make the most appropriate decisions by having enough information.

Thanks to the tremendous progress in the network technology, ordinary commercial behaviors combing with the network technology produce a new phenomenon which is called E-commerce in business. Since computer networks have been very popular, E-commerce has become an important developing point of all enterprises. Following the trend, corporate owners are rapidly integrating the internal structures of their companies and establish E-commerce links with others. Consumers are also directed into this kind of electronic consumption behavior.

Most early applications of the E-commerce were on normal home computers. As the wireless transmissions at the time could not transfer too many data, its development is very limited. After the continuous progress in the technology for a few years, the transmission problem had been gradually solved. Therefore, the idea of combining electronic devices accessible to the web and the E-commerce is brought to wide attention. In the end, no matter where we go, we can always obtain the latest information and purchase desired articles through a network electronic device.

It is a pity that most of current E-commerce is not a combined shopping center of certain products or an independent shopping center of a specific group. There may be only one price provided for each product and therefore it is hard to stimulate people's consumption. From the viewpoint of consumers, it is most desirable to be able to obtain what they want at the lowest price. Nevertheless, it is usually quite troublesome for consumers to compare prices. Instead of diminishing drugstores and convenience stores in the traditional business mode, most people nowadays go to wholesale stores or shopping malls (hereinafter generally referred as shopping centers) to purchase daily necessities.

If we combine both the products sold in shopping centers and the concept of E-commerce and classify the locations of all shopping centers according to their areas, then consumers can readily obtain the sale prices of a particular commodity in all shopping centers in a certain area through their personal electronic devices connected to the Internet. Therefore, users can make a comparison among the shopping centers to determine where to purchase the commodity. In this way, consumers can purchase most satisfactory commodities without visiting several stores and comparing prices. Furthermore, consumers can make payments directly on the electronic device connecting to the Internet and have the commodities delivered to designated address.

### SUMMARY OF THE INVENTION

In observation of the problems in the prior art, it is an objective of the invention to provide a web shopping system and method. The invention utilizes the Internet to link a server at the server end and a client at the client end. Through an OI (operating interface) of the system, commodity trading is performed by entering keywords.

Another objective of the invention is to provide a web shopping system so that users can use their network connecting electronic devices to purchase a most satisfactory commodity.

The disclosed system includes at least one web shopping system server and at least one shopping center commodity information server. The web shopping system server further contains a main system database, a data access module, a data buffer module, a central operation control module and a display module.

The main system database performs the storage and retrieval of information in the shopping center commodity information server. The data access module links with the main system database for performing the storage and retrieval of information in the shopping center commodity information server. The data buffer module temporarily stores information and provides commodity information lists and purchase orders. The central operation control module is connected with the shopping center information server and all other modules of the system to receive/transmit and process data among various modules and the shopping center information server. The display module is connected with the central operation control module for displaying data transmitted from the central operation control module.

### BRIEF DESCRIPTION OF THE DRAWINGS

The invention will become more fully understood from the detailed description given hereinbelow illustration only, and thus are not limitative of the present invention, and wherein:

FIG. 1 is a schematic view showing the connections between various electronic processors used by users and the web shopping system server and the shopping center server group;

FIG. 2-A is a flowchart showing how a user uses the disclosed system to click a desired commodity; and

FIG. 2-B is a flowchart showing how a user uses the disclosed system to purchase a commodity and to confirm the payment and delivery methods for the commodity.

### DETAILED DESCRIPTION OF THE INVENTION

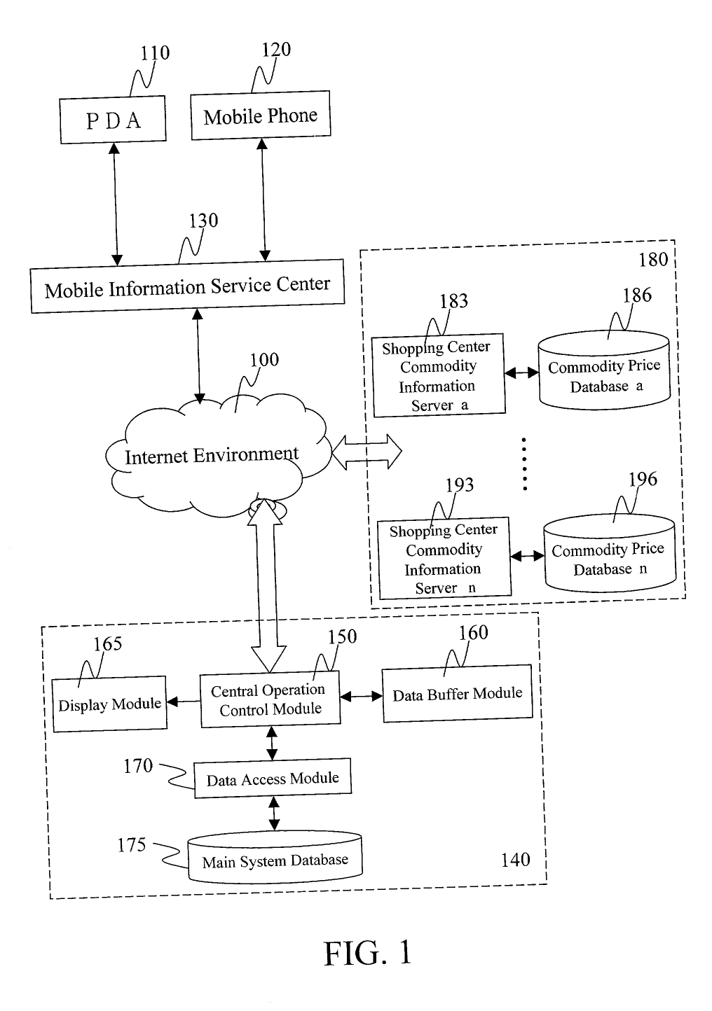

A web shopping system and method is proposed in this specification. The invention is applied to electronic device accessible to the Internet. Through an OI (operating interface) of the disclosed system, a user can obtain sale commodity information by entering keywords to perform transactions. The electronic devices accessible to the network can be PDA's (personal digital assistant), mobile phones, notebook PC's, desktop PC's, and indoor intelligent telephones. We take an embodiment shown in FIG. 1 to demonstrate the operation of the whole system. When a user wants to enter the system, the user can choose to use such devices as a PDA 110 or a mobile phone 120 for the system to connect to the Internet environment 100. In particular, the devices such as the PDA 110 and the mobile phone 120 are connected to the Internet environment 100 through a mobile information service center 130. During the connecting process, the above-mentioned electronic devices accessible to the network use a specific transfer protocol for communications and data transfers. Such transfer protocols include HTTP (hypertext transfer protocol), FTP (file transfer protocol), WAP (wireless application protocol), GPRS (general packet radio service), IR (infrared) WAP, and Bluetooth. The structure of the invention includes at least a web shopping system server 140 and at least one shopping center commodity information server. The web shopping system server 140 contains a main system database 175, a data access module 170, a data buffer module 160, a central operation control module 150, and a display module 165.

The main system database 175 stores and retrieves location information of the shopping center commodity information server. The data access module 170 is connected to the main system database 175 for storing and retrieving location information of the shopping center commodity information server. The data buffer module 160 temporarily stores information and provides commodity information lists and purchase orders. The central operation control module 150 is connected with the shopping center information server and all other modules of the system to receive/transmit and process data among various modules and the shopping center information server. The display module 165 is connected with the central operation control module for displaying data transmitted from the central operation control module.

After the user connects to the web shopping system server 140 of the disclosed system, the user can enter keywords of a particular commodity through the OI of the system to purchase commodities. After the user enter some keywords, the central operation control module 150 of the system produces and sends a data message to the data access module 170 for the data access module 170 to read the path of shopping center commodity information server that is connected to the web shopping system server 140 from the main system database 175. The path information is then sent to the central operation control module 150 to search commodity information related to the keywords among the databases of all shopping center commodity servers in the shopping center commodity information server group 180. (The group includes a plurality of shopping center commodity information servers, namely, the shopping center commodity information server a 183, . . . , shopping center commodity information server n 193. Each shopping center commodity information server corresponds to a commodity price database, namely, the shopping center commodity information server a 183 corresponding to a commodity price database a 186, . . . , and the shopping center commodity information server n 193 corresponding to a commodity price database a 196.) Before the searching is completed, all found data are first transferred back to the central operation control module 150 and temporarily stored in the data buffer module 160. After all data searching is done, the data buffer module 160 sends temporarily stored data to the central operation control module 150. The central operation control module 150 organizes the data and makes a commodity information list, which is then sent to the display module 165 to display. The contents in the commodity information list contain such commodity information as manufacturers, brands, commodity titles, serial numbers, prices, and locations of the shopping center commodity information servers. Such shopping center information includes names, areas, and locations of the shopping centers.

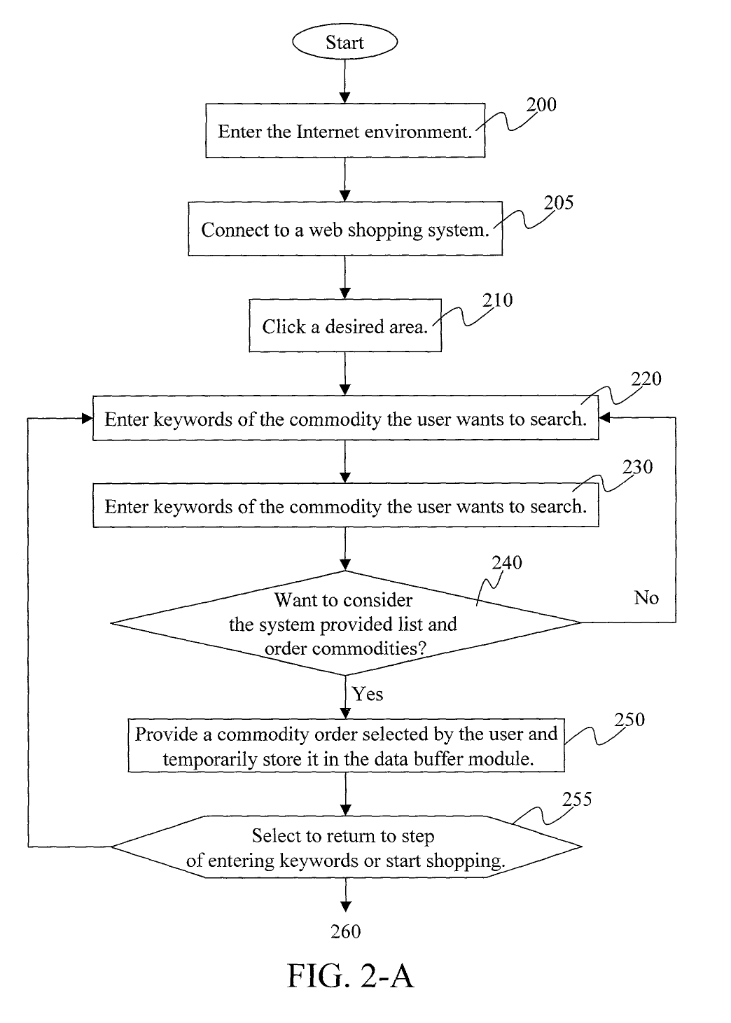

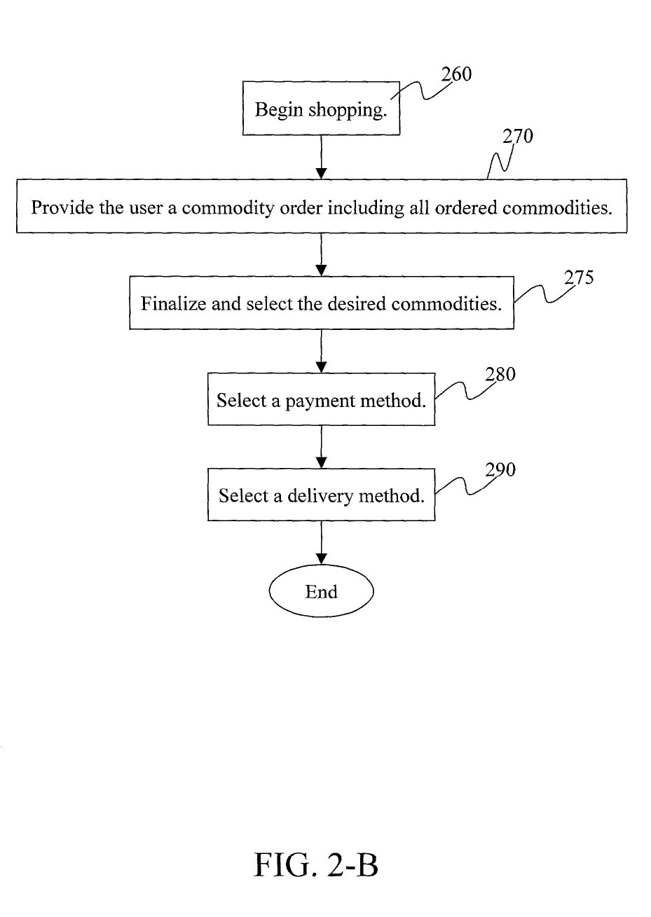

In the following paragraph, we take FIGS. 2-A and 2-B to explain the explicit operations of the disclosed system. With reference to FIG. 2-A, after a user enters the Internet environment (step 200) and connects to the web shopping system (step 205), the system provides all areas for the user to select. When the user clicks a desired area (step 210), the system asks the user to enter keywords for the system to search and organize commodity information of interest to the user. After the user enters the keywords (step 220), the system provides a list of commodity information related to the keywords (step 230) and asks the user whether he or she wants to consider the listed commodities (step 240). If the list does not have the items the user wants, the user can discard the list and return to the step of entering keywords (step 220). If the list contains the desired items, the user can select the commodities. After the selection is done, the system makes all the selected commodities into a commodity order and temporarily stores it in the data buffer module 160 (step 250). Afterwards, the system asks the user whether he or she wants to go back to the step of entering commodity keywords or to start shopping (step 255). If selecting to return to the step of entering commodity keywords (step 220), the user can continue entering keywords and search other commodities. If the user selects to start shopping (step 260), then the next step follows.

Referring to FIG. 2-B, after the user chooses to start shopping (step 260), the system retrieves all commodity orders placed by the user from the data buffer module 160 and provides the user all of the commodity orders (step 270). The user is then asked to confirm the orders again. After the user confirms the orders (step 275), the system asks the user one by one which the payment is preferred for each commodity in the order. After the payment method is specified (step 280), the user is further asked to choose a delivery method (step 290). This completes the system operation of purchasing commodities.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A web shopping system for a networking electronic device to link a server with a client via a Internet environment using a transfer protocol for making a commodity transaction through an OI (operating interface) of the system, the system comprising:
a shopping center commodity information server storing and retrieving a commodity information of the shopping center; and
a web shopping system server linking to the shopping center commodity information server for establishing and deleting a linking path of the shopping center information server and stores and retrieves a location information of the shopping center commodity information server.

2. The system of claim 1, wherein the Internet environment is a network structure with the functions of communications and data transfers.

3. The system of claim 1, wherein the transfer protocol is selected from the group consisting of HTTP (hypertext transfer protocol), FTP (file transfer protocol), WAP (wireless application protocol), GPRS (general packet radio service), IR (infrared) WAP, and Bluetooth.

4. The system of claim 1, wherein the commodity information comprises manufacturers, brands, commodity titles, commodity serial numbers, and commodity prices.

5. The system of claim 1, wherein the location information of the shopping center commodity information server comprises a shopping center name, a shopping center area and a shopping center location.

6. The system of claim 1, wherein the shopping center system server comprising:
a main system database storing the location information of the shopping center commodity information server;
a data access module connecting the main system database for storing and retrieving location information of the shopping center commodity information server;
a data buffer module, which temporarily stores a information and provides a commodity information list and a purchase order;
a central operation control module connecting with the shopping center commodity information server and all other modules of the system to receive/transmit and process data among the modules and the shopping center commodity information server; and
a display module connecting with the central operation control module for displaying data transmitted from the central operation control module.

7. The system of claim 6, wherein the information comprises the commodity information and the location information of the shopping center commodity information server.

8. The system of claim 6, wherein the commodity information list comprises the commodity information and the location information of the shopping center commodity information server.

9. The system of claim 6, wherein the purchase order is converted from the commodity information list, comprising the commodity information and the location information of the shopping center commodity information server.

10. A web shopping method for a networking electronic device to link a server with a client via a Internet environment using a transfer protocol for making a commodity transaction through an OI (operating interface) of a shopping system, the method comprising the steps of:
selecting a desired area, entering a keyword and sending out a searching command;
providing a commodity information list with the keyword according to the searching command;
selecting a desired commodities to purchase from the provided commodity information list;
forming a commodity purchase order according to the selected commodity information list;
confirming the purchase of the selected desired commodities in the commodity purchase order;
choosing a payment method for the commodities; and
choosing a delivery method of the commodities.

11. The method of claim 10, wherein the Internet environment is a network structure with the functions of communications and data transfers.

12. The method of claim 10, wherein the transfer protocol is selected from the group consisting of HTTP (hypertext transfer protocol), FTP (file transfer protocol), WAP (wireless application protocol), GPRS (general packet radio service), IR (infrared) WAP, and Bluetooth.

13. The method of claim 10, wherein the commodity information list is generated by including all commodities with the keyword.

14. The method of claim 10, wherein the commodity information list comprises a commodity information and a location information of the shopping center information server.

15. The method of claim 14, wherein the commodity information comprises manufacturers, brands, commodity titles, commodity serial numbers, and commodity prices.

16. The method of claim 14, wherein the location information of the shopping center commodity information server comprises a shopping center name, a shopping center area and a shopping center location.

17. The method of claim 10, wherein the purchase order is converted from the commodity information list, comprising the commodity information and the location information of the shopping center commodity information server.

18. The method of claim 10, wherein the payment method is selected from the group consisting of credit card payment method and cash payment method.

19. The method of claim 10, wherein the delivery method is selected from the group consisting of consumer picking up in person, shipping by the shopping center, and delivering purchased commodities to a designated location for the consumer to pick up.
